(19) United States
(12) Patent Application Publication
(10) Pub. No.: US 2021/0140519 A1
(43) Pub. Date: May 13, 2021

(54) Tensioner With A Sliding Tensioner Arm Assembly

(71) Applicant: BorgWarner Inc., Auburn Hills, MI (US)

(72) Inventors: Lorenzo Caprotti, Vimercate (IT); Massimo Carugati, Vimercate (IT)

(21) Appl. No.: 17/079,770

(22) Filed: Oct. 26, 2020

Related U.S. Application Data
(60) Provisional application No. 62/932,747, filed on Nov. 8, 2019.
(60) Provisional application No. 62/962,534, filed on Jan. 17, 2020.

(51) Int. Cl. F16H 7/12; F16H 7/08

(52) U.S. Cl. CPC F16H 7/1281; F16H 7/1209; F16H 7/0829; F16H 2007/0806; F16H 2007/0893; F16H 2007/081; F16H 2007/0842; F16H 2007/0865; F16H 2007/0804

(57) ABSTRACT

A tensioner that includes a mount, a pair of tensioner arms, and a spring. The mount defines a movement axis. Each tensioner arm assembly has a first tensioner arm, which is coupled to the mount for sliding movement about the movement axis, a tensioner pulley and a spring guide. The tensioner pulley and the spring guide are coupled to an associated tensioner arm for movement therewith. The spring is mounted on the spring guides and biases the tensioner arm assemblies about the movement axis in respective directions that urge the tensioner pulleys toward one another.

### CROSS-REFERENCE TO RELATED APPLICATIONS

This application claims the benefit of U.S. Provisional Application No. 62/932,747 filed Nov. 8, 2019 and the benefit of U.S. Provisional Application No. 62/962,534 filed Jan. 17, 2020. The disclosures of the above-referenced applications are incorporated by reference as if fully set forth in detail herein.

### FIELD

The present disclosure relates to a tensioner with a sliding tensioner arm assembly.

### BACKGROUND

This section provides background information related to the present disclosure which is not necessarily prior art.

Hybrid vehicles that utilize start-stop technology (i.e., PO hybrid vehicles) commonly utilize a belt drive to transmit rotary power between an internal combustion engine and a motor-generator. Rotary power produced by the internal combustion engine can be employed to drive the motor-generator to cause the motor-generator to produce electrical power. Rotary power produced during the operation of the motor-generator can be employed to drive the internal combustion engine to start the internal combustion engine.

Typically, a tensioner will be employed in the belt drive to tension a drive belt sufficiently so that the drive belt does not slip relative to any of the various pulleys that receive power from or transmit power to the drive belt. Such tensioners are subject to relatively high changes in loading over a start-stop cycle and more particularly, over a period of time in which the motor-generator is energized to produce power and thereafter the internal combustion engine operates to drive the motor-generator. Accordingly, there is a need for such tensioners to be highly robust due to the high changes in loading that occur over the course of a stop-start cycle and an expected high rate of occurrence of start-stop cycles.

### SUMMARY

This section provides a general summary of the disclosure, and is not a comprehensive disclosure of its full scope or all of its features.

In one form, the present disclosure provides a tensioner having a mount, a first tensioner arm assembly, a second tensioner arm assembly, and a tensioner spring. The mount defines a movement axis that extends through the mount. The first tensioner arm assembly has a first tensioner arm, a first tensioner pulley and a first spring guide. The first tensioner arm is coupled to the mount for sliding movement about the movement axis. The first tensioner pulley and the first spring guide are coupled to the first tensioner arm for movement therewith. The second tensioner arm assembly has a second tensioner arm, a second tensioner pulley and a second spring guide. The second tensioner arm is coupled to the mount. The second tensioner pulley and the second spring guide are coupled to the second tensioner arm. The tensioner spring is mounted on the first and second spring guides and biases the first and second tensioner arm assemblies about the movement axis in respective directions that urge the first and second tensioner pulleys toward one another. The second arm assembly is slidably movable about the movement axis relative to the mount.

In some forms, the first tensioner arm includes first and second arm members that are fixedly coupled to one another. In some optional forms, the mount includes a mount member and a bearing rail. The bearing rail being coupled to the mount member and is disposed axially between the mount member and one of the first and second arm members. In some optional forms, the tensioner further includes first and second wipers that are each disposed within a respective end of the first tensioner arm and which are sealingly engaged to the bearing rail and to the one of the first and second arm members.

In some forms, the tensioner includes a damper disposed axially between the first tensioner arm and the bearing rail. Optionally, the damper includes a damper member and a damper spring. In some forms, the damper spring includes a Belleville spring washer. Optionally, the damper member is non-rotatably coupled to the first tensioner arm and is movable relative to the first tensioner arm along a respective damper axis that is parallel to the movement axis.

In some forms, the mount defines a plurality of fastener apertures that are configured to receive a fastener therethrough to fixedly but removably couple the mount to a motor-generator. The first arm member defines an installation aperture. Alignment of the installation aperture to a respective fastener aperture permits an associated one of the fasteners to be inserted through the first arm member and into the respective fastener aperture. Optionally, the tensioner includes a seal that is coupled to the first arm member and disposed about the installation aperture. The seal is sealingly engaged to the first arm member and to the mount when one of the fastener apertures is disposed entirely within the installation aperture.

In some forms, the first tensioner arm comprises a pivot hub, which is fixedly coupled to the first arm member, and wherein the spring guide is pivotally mounted on the pivot hub. Optionally, the spring guide includes a pivot body and a first protrusion that extends radially outwardly from the pivot body. The tensioner spring includes a compression spring having opposite ends. One of the opposite ends of the compression spring is received over the first protrusion.

In some forms, the tensioner spring includes a first spring and a second spring. Optionally, the first and second springs are the same type of spring. Optionally, the first and second springs are disposed in a series relationship. Optionally, the first spring has a first spring end, which is mounted on the first spring guide, and a second spring end, while the second spring has a third spring end, which is mounted on the second spring guide, and a fourth spring end. A guide member is disposed between the first and second springs and the second and fourth spring ends are mounted on the guide member. Optionally, the guide member is movably coupled to the mount.

In some forms, the tensioner spring comprises a plurality of springs that are disposed in a parallel relationship. In some forms, the plurality of springs include at least two different types of springs. In some further forms, one of the at least two different types of springs is a clock spring. In some further forms, one of the at least two different types of springs is a spring band. Optionally, the first tensioner arm includes a third spring guide, the second tensioner arm includes a fourth spring guide, the first spring is mounted on the first and second spring guides, and the second spring is mounted on the third and fourth spring guides.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a front perspective view of an exemplary tensioner constructed in accordance with the teachings of the present disclosure;

FIG. 2 is a front exploded perspective view of the tensioner of FIG. 1;

FIG. 3 is a rear exploded perspective view of the tensioner of FIG. 1;

FIG. 4 is a section view taken along the line 4-4 of FIG. 1;

FIG. 5 is a section view taken perpendicular to a movement axis and through a pair of tensioner pulleys and a pair of pivot guides;

FIG. 6 is a section view taken along the line 5-5 of FIG. 1;

FIG. 7 is a front perspective view of a second exemplary tensioner constructed in accordance with the teachings of the present disclosure;

FIG. 8 is a front exploded perspective view of the tensioner of FIG. 7;

FIG. 9 is a rear exploded perspective view of the tensioner of FIG. 7;

FIG. 10 is a front perspective view of the tensioner of FIG. 7 with the tensioner spring removed;

FIG. 11 is a front elevation view of the tensioner of FIG. 7 with the tensioner spring removed;

FIG. 12 is a rear perspective view of the tensioner of FIG. 7 with the tensioner spring removed;

FIG. 13 is a cross-sectional view taken along the line 13-13 of FIG. 11;

FIG. 14 is a front elevation view of a third tensioner constructed in accordance with the teachings of the present disclosure;

FIG. 15 is a front perspective view of the tensioner of FIG. 14;

FIG. 16 is a perspective view of a portion of the tensioner of FIG. 14, illustrating a second spring guide in more detail;

FIG. 17 is a front elevation view of a fourth tensioner constructed in accordance with the teachings of the present disclosure

FIG. 18 is a perspective view of a portion of the tensioner of FIG. 17 illustrating the tensioner spring in more detail;

FIG. 19 is a front elevation view of a fifth tensioner constructed in accordance with the teachings of the present disclosure

FIG. 20 is a perspective view of the tensioner of FIG. 19 illustrating tangs on the tensioner spring in more detail;

FIG. 21 is a front elevation view of a portion of a sixth tensioner constructed in accordance with the teachings of the present disclosure;

FIG. 22 is a front perspective view of the portion of the tensioner shown in FIG. 21; and

FIG. 23 is a perspective view of a portion of still another tensioner constructed in accordance with the teachings of the present disclosure.

Corresponding reference numerals indicate corresponding parts throughout the several views of the drawings.

### DETAILED DESCRIPTION

With reference to FIGS. 1 through 3, a tensioner constructed in accordance with the teachings of the present disclosure is generally indicated by reference numeral 10. The tensioner 10 is configured for use tensioning a drive belt (not shown) of a PO hybrid in which the drive belt is employed to transmit rotary power to and from a motor-generator (not shown). The tensioner 10 can include a mount 12, a first tensioner arm assembly 14, a second tensioner arm assembly 16, and a tensioner spring 18.

The mount 12 is configured to be fixedly coupled to a stationary structure, such as the motor-generator, a bracket (not shown) for holding the motor-generator, or to an internal combustion engine (not shown). The mount 12 defines a movement axis 20 that defines or helps to define the manner of relative movement (i.e., translation) between the first and second tensioner arm assemblies 14 and 16 and the mount 12. In the particular example provided, the first and second tensioner arm assemblies 14 and 16 translate in a circular path defined by the movement axis 20, and the movement axis 20 is configured to be aligned to (i.e., coincident with) a rotational axis of the input/output shaft (not shown) of the motor-generator as well as to the rotational axis of a pulley (not shown) that is non-rotatably coupled to the input/output shaft and which is also engaged to the drive belt. It will be appreciated, however, that the movement axis 20 could be parallel to but offset from the rotational axes of the input/output shaft and motor-generator pulley, or could be configured as one or more segments that could be oriented transverse to the rotational axes of the input/output shaft and motor-generator pulley.

With reference to FIGS. 3 and 4, the mount 12 can comprise a mount member 22 and a bearing rail 24. The mount member 22 can be formed of any desired material, such as aluminum, steel, or a reinforced, rigid plastic material, and can generally conform to one or more pathways 28 (FIG. 5) along which the first tensioner arm assembly 14 and optionally the second tensioner arm assembly 16 can move relative to the mount 12. The bearing rail 24 can generally conform to the one or more pathways 28 (FIG. 5) and is configured to be fixedly coupled to the mount member 22. The bearing rail 24 can be formed of an appropriate material, such as a hardened steel, and can provide a hard surface on which the first tensioner arm assembly 14 and optionally the second tensioner arm assembly 16 can move relative to the mount 12. The mount member 22 and the bearing rail 24 are ring-shaped in the example provided, but it will be understood that they could be shaped differently and need not extend continuously about the movement axis 20. For example, the mount member 22 and the bearing rail 24 could be shaped as an annular sector or in a generally V-shaped manner so that the movement axis 20 is correspondingly V-shaped.

With specific reference to FIG. 4, the mount member 22 can have flat front and rear surfaces 32 and 34, respectively, flat radially inner and outer surfaces 36 and 38, respectively, a radially inner tapered surface 40, and a radially outer tapered surface 42. The rear surface 34 is configured to abut the structure to which the mount 12 is to be fixedly coupled. The radially inner and outer surfaces 36 and 38 can be concentrically disposed about the movement axis 20 (FIG. 3). The radially inner tapered surface 40 can extend between the rear surface 34 and the radially inner surface 36, while the radially outer tapered surface 42 can extend between the rear surface 34 and the radially outer surface 38.

The bearing rail 24 can be formed of a sheet-steel material and can generally conform to the front surface 32, the radially inner and outer surfaces 36 and 38, and the radially inner and outer tapered surfaces 40 and 42. The bearing rail 24 can define a front thrust surface 52, a radially inner thrust surface 56, an inner tapered thrust surface 58, an outer tapered thrust surface 60, and a radially outer thrust surface 62.

With renewed reference to FIGS. 2 and 3, fastener apertures 66 can be formed through the mount 12 (i.e., through the bearing rail 24 and the mount member 22) and can receive fasteners 68 therethrough to permit the mount 12 to be fixedly but removably coupled to the structure (e.g., motor-generator).

With reference to FIGS. 1 and 2, the first tensioner arm assembly 14 can include a tensioner arm 70, a tensioner pulley 72, and a spring guide 74. The tensioner arm 70 is coupled to the mount 12 for sliding movement relative to the movement axis 20. In the example provided, the tensioner arm 70 translates about the movement axis and comprises a front arm member 80, a first rear arm member 82, a second rear arm member 84, and a plurality of fasteners 86 that secure the first and second rear arm members 82 and 84 to the front arm member 80. The front arm member 80 can have an arm 90, a pulley hub 92, and a pivot hub 94. The front arm member 80 can be formed as a plurality of discrete components that are assembled together, or could be unitarily and integrally formed, for example by casting or forging.

With reference to FIGS. 2, 3, 4 and 6, the arm 90 can be formed as an annular segment and can define a first channel 100, which can define a rear channel surface 102, a first inner channel surface 104 and a first outer channel surface 106. The pulley hub 92 and the pivot hub 94 can be cylindrical projections that extend forwardly from the front arm member 80 and which have an internally threaded hole 108 formed therein.

The first rear arm member 82 can be formed as an annular segment and can be abutted to the rear surface of the front arm member 80 at a radially inner side of the front arm member 80. The first rear arm member 82 can define a second inner channel surface 110 and an inner channel thrust surface 112. The second rear arm member 84 can be formed as an annular segment and can be abutted to the rear surface of the front arm member 80 at a radially outer side of the front arm member 80. The second rear arm member 84 can define a second outer channel surface 114 and an outer channel thrust surface 116. The threaded fasteners 86 are received through the front arm member 80 and are threadably engaged to threaded holes 118 formed in the first and second rear arm members 82 and 84. It will be appreciated, however, that the components of the tensioner arm 70 can be fixedly coupled to one another in any desired manner, including staking or welding. As assembled, the front arm member 80 and the first and second rear arm members 82 and 84 cooperate to define an arcuate slot 120 into which the mount 12 is received. More specifically, the rear channel surface 102 on the front arm member 80 is abutted to the front thrust surface 52 on the bearing rail 24, the first and second inner channel surfaces 104 and 110 on the front arm member 80 and the first rear arm member 82 are abutted to the radially inner thrust surface 56 on the bearing rail 24, the first and second outer channel surfaces 106 and 114 on the front arm member 80 and the second rear arm member 84 are abutted to the radially outer thrust surface 62 on the bearing rail 24, the inner channel thrust surface 112 on the first rear arm member 82 is abutted to the inner tapered thrust surface 58 on the bearing rail 24, and the outer channel thrust surface 116 on the second rear arm member 84 is abutted to the outer tapered thrust surface 60 on the bearing rail 24. It will be appreciated that the radially inner thrust surface 56 and the radially outer thrust surface 58 can cooperate with the first and second inner channel surfaces 104 and 110 and the first and second outer channel surfaces 106 and 114, respectively, to guide the tensioner arm 70 as it translates on the mount 12 relative to the movement axis 20.

With reference to FIGS. 3 and 6, the first tensioner arm assembly 14 can optionally include dampers 150 that are received axially between the front arm member 80 and the bearing rail 24 and which urge the radially inner and outer channel thrust surfaces 112 and 116 into engagement with the radially inner and outer tapered thrust surfaces 58 and 60, respectively, to thereby center the tensioner arm 70 on the mount 12 and guide the tensioner arm 70 as it translates on the mount 12 relative to the movement axis 20. It will also be appreciated that the dampers 150 and the radially inner and outer channel thrust surfaces 112 and 116 cooperate to limit axial movement of the tensioner arm 70 along the movement axis 20 relative to the mount 12.

Generally, each of the dampers 150 can comprise a damper spring 160 and a damper member 162. The damper spring 160 can be any type of spring, such as a helical coil compression spring or a wave spring. In the example shown, the damper spring 160 comprises a Belleville spring washer that is received into a damper bore 164 formed into the rear side of the front arm member 80 concentrically with an associated one of the internally threaded holes 108. The damper member 162 can include a damper body 166 and a pair of projections 168 that extend radially outwardly from the damper body 166. The damper body 166, which can be shaped as a cylindrical plinth (i.e., a short, right cylindrical object), can be sized to be at least partially received into the damper bore 164. The projections 168 can be received into recesses 170 that are formed into the front arm member 80 and which intersect the damper bore 164. Receipt of the projections 168 into the recesses 170 inhibits rotation of the damper member 162 relative to the front arm member 80.

A first side of the damper body 166 can abut the damper spring 160, while a second, opposite side of the damper body 166 can abut the front thrust surface 52 of the bearing rail 24. The damper member 162 can be unitarily formed from a desired material, such as a hardened steel or a creep-resistant plastic. Optionally, the damper member 162 can include a coating, particle and/or a layer of material that provides the damper body 166 with a desired set of tribological characteristics. The damper member 162 is movable relative to the tensioner arm 70 along a respective damper axis 174 that is parallel to the movement axis 20.

With reference to FIGS. 2, 3 and 6, the first tensioner arm assembly 14 can optionally include first and second wipers 182 and 184 that are configured to inhibit the ingress of dirt, debris and moisture between the front arm member 80 and the bearing rail 24 when the tensioner arm 70 is translated relative to the movement axis 20. Each of the first and second wipers 182 and 184 can be disposed within a respective end of the front arm member 80 and can be sealingly engaged to the front thrust surface 52, the radially inner and outer thrust surfaces 56 and 62, and the radially inner and outer thrust surfaces 58 and 60 of the bearing rail 24, to the rear channel surface 102 and the first inner and outer channel thrust surfaces 104 and 106 on the front arm member 80, to the second inner channel thrust surface 112 and the radially inner tapered channel thrust surface 112 on the first rear arm member 82, and to the second outer channel thrust surface 114 and the radially outer tapered channel thrust surface 116 on the second rear arm member 84.

With reference to FIGS. 1 and 3, the front arm member 80 can define an installation aperture 190 that can be aligned to a respective fastener aperture 66 in the mount 12 to permit an associated one of the fasteners 68 to be inserted through the front arm member 80 and into the respective fastener aperture 66 when the mount 12 is secured to the structure (e.g., motor-generator). If desired, a perimeter seal 192 could be coupled to the front arm member 80 and disposed about the installation aperture 190. The perimeter seal 192 can sealingly engage the front arm member 80 and the bearing rail 24 when the fastener aperture 66 is disposed entirely within the installation aperture 190 to inhibit migration of dirt, debris and moisture through the installation aperture 190 and between the front arm member 80 and the bearing rail 24.

With reference to FIGS. 2 and 5, the tensioner pulley 72 can include a bearing 200 and a tensioner wheel 202. The inner bearing race 206 of the bearing 200 can be disposed over the pulley hub 92 and a fastener 208 can be threadably engaged to the internally threaded aperture 108 in the pulley hub 92 to fixedly couple the inner bearing race 206 of the bearing 200 to the pulley hub 92. The tensioner wheel 202 can be fixedly coupled to an outer bearing race 210 of the bearing 200. Accordingly, it will be appreciated that the tensioner pulley 72 is coupled to the tensioner arm 70 for movement therewith.

The spring guide 74 is mounted to the tensioner arm 70 and is configured to support the tensioner spring 18 as the tensioner spring 18 urges the tensioner arm 70 in a predetermined direction relative to the movement axis 20. Accordingly, it will be appreciated that the spring guide 74 is coupled to the tensioner arm 70 for movement therewith. In the example provided, the spring guide 74 is pivotally coupled to the tensioner arm 70. More specifically, the spring guide 74 is pivotally received on the pivot hub 94 and an associated one of the fasteners 208 secures the spring guide 74 to the pivot hub 94. The spring guide 74 can have a pivot body 220 and first and second protrusions 222 and 224, respectively, that extend radially outwardly from the pivot body 220. In the example shown, a through-hole 226 is formed through each of the first and second protrusions 222 and 224 in a direction that is parallel to an axis about which the spring guide 74 pivots on the pivot hub 94.

The second tensioner arm assembly 16 can comprise a (second) tensioner arm, a (second) tensioner pulley and a (second) spring guide. In the example provided, the second tensioner arm assembly 16 is configured in a manner that is similar to that of the first tensioner arm assembly 14 and is likewise slidably movable on the mount 12 relative to the movement axis 20. As such, a detailed description of the second tensioner arm assembly 16 need not be provided herein. Components of the second tensioner arm assembly 16 that are shown in the drawings will be identified with the reference numerals used in the discussion of the components of the first tensioner arm assembly 14, above. It will be appreciated, however, that the second tensioner arm assembly 16 could be configured somewhat differently. For example, the second tensioner arm could be pivotally coupled to the mount 12 or to the tensioner arm 70.

The tensioner spring 18 is mounted on the spring guides 74 of the first and second tensioner arm assemblies 14 and 16 and biases the first and second tensioner arm assemblies 14 and 16 such that the tensioner pulleys 72 are biased toward one another. In the example provided, the tensioner spring 18 is a helical coil compression spring and each axial end of the tensioner spring 18 is mounted on (i.e., received over) the first protrusions 222 on an associated one of the spring guides 74 so that the first and second tensioner arm assemblies 14 and 16 are urged about the movement axis 20 in respective directions (i.e., along the respective pathways 28 (FIG. 5)) to drive the tensioner pulleys 72 toward one another.

With reference to FIG. 1, a stopper 250, which can be formed of wire, can be received into the through-holes 226 in the second protrusions 224 to retain the first and second tensioner arm assemblies 14 and 16 in a desired proximity toward one another. With the stopper 250 engaged to the second protrusions 224, the first and second tensioner arm assemblies 14 and 16 can be translated about the movement axis 20 together (i.e., as a set) relative to the mount 12. Configuration in this manner permits the first and second tensioner arm assemblies 14 and 16 to be rotated about the mount 12 to align the installation apertures 190 to the fastener apertures 66. Thereafter, the fasteners 68 can be received through both the installation apertures 190 and the fastener apertures 66 and threadably coupled to the structure to which the tensioner 10 is to be mounted (e.g., the motor-generator). Configuration in this manner also permits the tensioner pulleys 72 to be moved to a desired orientation to permit the drive belt to be routed in a desired manner. Thereafter, the stopper 250 can be removed from the second protrusions 224 to permit the tensioner spring 18 to drive the tensioner arms 70 about the movement axis 20 in respective directions and move the tensioner pulleys 72 toward one another.

With reference to FIGS. 7 to 13, a second tensioner constructed in accordance with the teachings of the present disclosure is generally indicated by reference numeral 10a. The tensioner 10a is generally similar to the tensioner 10 of FIG. 1, except that the tensioner spring 18a is constructed as a spring band, each of the tensioner arms 70a is formed of a front arm member 80a and a single rear arm member, and the spring guides 74a are fixedly coupled to the front arm members 80a. Each of the spring guides 74a is “J-shaped” and defines a channel into which an end of the tensioner spring 18a can be received. It will be appreciated that the spring guides 74a can be unitarily and integrally formed with the front arm members 80a or that the spring guides 74a could be formed as discrete components that are assembled to the front arm members 80a. In operation, the tensioner spring 18a acts as a torsion spring that drives the first and second tensioner arms 14a and 16a about the movement axis 20 toward one another.

As shown in FIG. 11, the fasteners 86a that secure the several components of the tensioner arms 70a together are rivets in this example. Additionally, the bearing rail 24a is shown in FIGS. 8, 9 and 13 to be formed of four discrete bearing rail components 300 that are assembled to the mount member 22a.

In the example of FIGS. 14 through 16, a third tensioner constructed in accordance with the teachings of the present disclosure is generally indicated by reference numeral 10b. The tensioner 10b is generally similar to the tensioner 10 of FIG. 1 except that the tensioner spring 18b comprises a pair of compression springs 400 and a second spring guide 402, and each of the spring guides 74b is fixedly coupled to a tensioner arm 70b of an associated one of the first and second tensioner arm assemblies 14b and 16b.

The second spring guide 402 can comprise a guide member 410 and a pair of spring mounts 412. The guide member 410 can be configured as a generally C-shaped structure that is configured to translate on the mount 12 about the movement axis (i.e., is slidably mounted on the mount 12) and can be constructed in a manner that is similar to the first tensioner arm 70 (FIG. 2). More specifically, the guide member 410 can wrap around the outer and inner circumferential edges of the mount 12, which resists removal of the guide member 410 from the mount 12 in an axial direction that is parallel to the movement axis. Alternatively, the guide member 410 can be configured in a manner similar to that of the tensioner arm 14 of FIG. 1 (i.e., with front and rear arm members that are assembled to one another via a plurality of fasteners). Also alternatively, the guide member 410 could be fixedly coupled to the mount 12. The spring mounts 412 can be fixedly coupled to the opposite lateral sides of the guide member 410. Each of the spring mounts 412 can have a spring guide portion 420 and a flange 422. The spring guide portion 420 can be a cylindrical structure that can extend from a lateral side of the guide member 410 in a direction that faces the spring guide 74b on a corresponding one of the first and second tensioner arm assemblies 14b and 16b. The flange 422 can extend radially from the spring guide portion 420. Each of the compression springs 400 can be received onto an associated one of the spring guides 74b and an associated one of the spring mounts 412. More specifically, a first end of each of the compression springs 400 can be received on an associated one of the spring guide portions 420 and can be abutted against a corresponding one of the flanges 422. Similarly, a second end of each of the compression springs 400 can be received on a generally cylindrically-shaped portion 426 of an associated one of the spring guides 74b and abutted against a flange 428 that extends radially outwardly from the cylindrically-shaped portion of the spring guide 74b.

In the example of FIGS. 17 and 18, a fourth tensioner constructed in accordance with the teachings of the present disclosure is generally indicated by reference numeral 10c. In this example, the tensioner spring 18c is an external torsion spring that formed of a spring wire so as to have a spring body 450, which is wound around the movement axis, and a pair of spring tangs 452 that extend radially inwardly from a spring body 450. In the example provided, the spring body 450 is wound one and a quarter (1.25) times around the mount 12 and the spring wire is formed with a circular lateral cross-section. It will be appreciated, however, that the wire that forms the spring body 450 could be wound about the mount 12 to a greater or lesser degree, and/or could be have a lateral cross-sectional shape that is non-circular (e.g., square, rectangular) in the alternative. Each of the spring tangs 452 is abutted against an associated one of the spring guides 74c, which are fixedly coupled to a tensioner arm 70c of an associated one of the first and second tensioner arm assemblies 14c and 16c.

The example of FIGS. 19 and 20 is similar that of the previous example in that the tensioner spring 18d is also an external torsion spring. However, the spring body 450d does not extend completely about the mount 12 and the spring tangs 452d engage spring guides 74d that are mounted to ends of the tensioner arms 70d of the first and second tensioner arm assemblies 14d and 16d. If desired, spring abutment members 460 can be formed on the tensioner arms 70d and can extend radially outwardly therefrom. The spring abutment members 460 are configured to limit tilting of the spring body 450d so that it is maintained in an orientation that is orthogonal to the movement axis.

In FIGS. 21 and 22, a portion of still another tensioner constructed in accordance with the teachings of the present disclosure is illustrated. The tensioner includes a tensioner spring 18e that is formed as a clock spring. The tensioner spring 18e can have a radially inner end 470, which abuts a first spring guide 74e-1 that is fixedly coupled to a first one of the tensioner arms 70e, a radially outer end 472, which abuts a second spring guide 74e-2 that is fixedly coupled to a second one of the tensioner arms 70e, and a spring body 450e that is wound in a spiral manner between the radially inner end 470 and the radially outer end 472.

The exemplary tensioners discussed in detail above and depicted in FIGS. 1 through 22 describe tensioners having a tensioner spring that consists of a single spring or of a pair of identical helical coil compression springs that are disposed in a series arrangement. It will be appreciated, however, that the tensioner spring could be formed of two or more springs that can be disposed in another arrangement, such as a parallel arrangement, and that the two or more springs need not be configured in an identical manner. In this regard, it may be desirable under some situations to form the tensioner spring with two or more springs that may be of different types (e.g., compression, tension, band, clock, torsion). One example of this alternative construction is depicted in FIG. 23 in which the tensioner spring 18f comprises a first spring 500 and a second spring 502. The first spring 500 is a spring band type of spring that is similar to that which is depicted in the example of FIGS. 7 to 13. The first spring 500 is also mounted to the tensioner arms 70f in a manner that is similar to that which is depicted in the example of FIGS. 7 to 13. More specifically, each of the tensioner arms 70f includes a first spring guide 74a having a slot or channel 504 into which a respective end of the first spring 500 can be received. The second spring 502 is a clock spring in the example provided and is similar to the clock spring that is employed in the example of FIGS. 21 and 22. The second spring 502 is mounted to the tensioner arms 70f. In the particular example provided, each of the tensioner arms 70f has a second spring guide 510 into which an associated end of the second spring 502 is received. As both the first and second springs 500 and 502 act directly on the tensioner arms 70f, it will be appreciated that that the first and second springs 500 and 502 are disposed in a parallel arrangement.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A tensioner (10) for tensioning a belt about a pulley, the tensioner (10) comprising:
a mount (12) defining a movement axis (20) that extends axially through the mount (12);
a first tensioner arm assembly (14) having a first tensioner arm (70, 70a, 70b, 70c, 70d, 70e, 70f), a first tensioner pulley (72) and a first spring guide (74, 74a, 74b, 74c, 74d, 74e-1, 74f), the first tensioner arm (70, 70a, 70b, 70c, 70d, 70e, 70f) being coupled to the mount (12) for sliding movement about the movement axis (20), the first tensioner pulley (72) and the first spring guide (74, 74a, 74b, 74c, 74d, 74e-1, 74f) being coupled to the first tensioner arm (70, 70a, 70b, 70c, 70d, 70e, 70f) for movement therewith;
a second tensioner arm assembly (16) having a second tensioner arm (70, 70a, 70b, 70c, 70d, 70e, 70f), a second tensioner pulley (72) and a second spring guide (74, 74a, 74b, 74c, 74d, 74e-2, 74f), the second tensioner arm (70, 70a, 70b, 70c, 70d, 70e, 70f) being coupled to the mount (12), the second tensioner pulley (72) and the second spring guide (74, 74a, 74b, 74c, 74d, 74e-2, 74f) being coupled to the second tensioner arm (70, 70a, 70b, 70c, 70d, 70e, 70f);
a tensioner spring (18, 18a, 18b, 18c, 18d, 18e, 18f) mounted on the first and second spring guides (74, 74a, 74b, 74c, 74d, 74e-2, 74e-2, 74f) and biasing the first and second tensioner arm assemblies (14, 16) about the movement axis (20) in respective directions that urges the first and second tensioner pulleys (72) toward one another;
wherein the second tensioner arm assembly (16) is slidably movable about the movement axis (20) relative to the mount (12).

2. The tensioner (10) of claim 1, wherein the first tensioner arm (70, 70a, 70b, 70c, 70d, 70e, 70f) comprises a first and second arm members (80, 82) that are fixedly coupled to one another.

3. The tensioner (10) of claim 2, wherein the mount (12) comprises a mount member (22, 22a) and a bearing rail (24, 24a), the bearing rail (24, 24a) being coupled to the mount member (22, 22a) and being disposed axially between the mount member (22, 22a) and one of the first and second arm members (80, 82).

4. The tensioner (10) of claim 3, further comprising first and second wipers (182, 184), each of the first and second wipers (182, 184) being disposed within a respective end of the first tensioner arm (70, 70a, 70b, 70c, 70d, 70e, 70f) and being sealingly engaged to the bearing rail (24, 24a) and to the one of the first and second arm members (80, 82).

5. The tensioner (10) of claim 3, further comprising a damper (150) disposed axially between the first tensioner arm (70, 70a, 70b, 70c, 70d, 70e, 70f) and the bearing rail (24, 24a).

6. The tensioner (10) of claim 5, wherein the damper (150) comprises a damper member (162) and a damper spring (160).

7. The tensioner (10) of claim 6, wherein the damper spring (160) comprises a Belleville spring washer.

8. The tensioner (10) of claim 6, wherein the damper member (162) is non-rotatably coupled to the first tensioner arm (70, 70a, 70b, 70c, 70d, 70e, 70f) and is movable relative to the first tensioner arm (70, 70a, 70b, 70c, 70d, 70e, 70f) along a respective damper axis (174) that is parallel to the movement axis (20).

9. The tensioner (10) of claim 2, wherein the mount (12) defines a plurality of fastener apertures (66), each of the fastener apertures (66) being adapted to receive a fastener (68) therethrough to fixedly but removably couple the mount (12) to a motor-generator, and wherein the first arm member (80) defines an installation aperture (190), wherein alignment of the installation aperture (190) to a respective fastener aperture (66) permits an associated one of the fasteners (68) to be inserted through the first arm member (80) and into the respective fastener aperture (66).

10. The tensioner (10) of claim 9, further comprising a seal (192) coupled to the first arm member (80) and disposed about the installation aperture (190), the seal (192) being sealingly engaged to the first arm member (80) and to the mount (12) when one of the fastener apertures (66) is disposed entirely within the installation aperture (190).

11. The tensioner (10) of claim 2, wherein the first tensioner arm (70) comprises a pivot hub (94), which is fixedly coupled to the first arm member (80), and wherein the first spring guide (74) is pivotally mounted on the pivot hub (94).

12. The tensioner (10) of claim 11, wherein the first spring guide comprises a pivot body (220) and a first protrusion (222) that extends radially outwardly from the pivot body (220), wherein the tensioner spring (18) includes a compression spring having opposite ends, and wherein one of the opposite ends of the compression spring is received over the first protrusion (222).

13. The tensioner (10) of claim 1, wherein the tensioner spring (18b, 18f) comprises a first spring (400, 500) and a second spring (400, 500).

14. The tensioner (10) of claim 13, wherein the first and second springs (400) are the same type of spring.

15. The tensioner (10) of claim 13, wherein the first and second springs (400) are disposed in a series relationship.

16. The tensioner (10) of claim 15, wherein the first spring (400) has first and second spring ends, the first spring end being mounted on the first spring guide (74b), wherein the second spring (400) has third and fourth spring ends, the third spring end being mounted on the second spring guide (74b), wherein a guide member (410) is disposed between the first and second springs (400), and wherein the second and fourth spring ends are mounted on the guide member (400).

17. The tensioner (10) of claim 16, wherein the guide member (410) is movably coupled to the mount (12).

18. The tensioner (10) of claim 1, wherein the tensioner spring (18f) comprises a plurality of springs (500, 502) that are disposed in a parallel relationship.

19. The tensioner (10) of claim 18, wherein the plurality of springs (500, 502) include at least two different types of springs.

20. The tensioner (10) of claim 19, wherein one of the at least two different types of springs is a clock spring.

21. The tensioner (10) of claim 19, wherein one of the at least two different types of springs is a spring band.

22. The tensioner (10) of claim 18, wherein the first tensioner arm (70f) comprises a third spring guide (510), wherein the second tensioner arm (70, 70a, 70b, 70c, 70d, 70e, 70f) comprises a fourth spring guide (510), wherein the first spring (500) is mounted on the first and second spring guides (74f), and wherein the second spring (502) is mounted on the third and fourth spring guides (510).
